(19) United States
(12) Patent Application Publication
(10) Pub. No.: US 2024/0177092 A1
(43) Pub. Date: May 30, 2024

(54) VISUAL PRESENTATION OF WORKFLOW PROGRESS

(71) Applicant: Rakuten Mobile, Inc., Tokyo (JP)

(72) Inventors: Vikas KUSHWAH, Madhya Pradesh (IN); Ashvin PAGARE, Madhya Pradesh (IN)

(21) Appl. No.: 17/756,416

(22) PCT Filed: Apr. 13, 2022
(86) PCT No.: PCT/US2022/024559

§ 371 Date: Oct. 19, 2023

(51) Int. Cl. G06Q 10/0633; G06F 9/451

(52) U.S. Cl. CPC G06Q 10/0633; G06F 9/451

(57) ABSTRACT

A workflow progress presentation device includes at least one processor, and at least one memory coupled to the at least one processor and configured to store executable instructions. The executable instructions, when executed by the at least one processor, cause the at least one processor to extract, from at least one data source, data corresponding to at least one element in a workflow diagram, and determine from the extracted data whether the at least one element is active or completed. The processor is caused to, in response to determining that the at least one element is active, visually present the at least one element in the workflow diagram by a first format, and in response to determining that the at least one element is completed, visually present the at least one element in the workflow diagram by a second format visually distinctive from the first format.

### TECHNICAL FIELD

The present disclosure is related to workflow and decision automation platforms, and particularly, to visual presentation of workflows in such platforms.

### BACKGROUND

Many industries, services, applications, businesses, etc. have procedures that are complex and prone to error due to various internal guidelines and/or external mandates. Workflows, or workflow diagrams, are developed to present such complex procedures in a manner that is easier for humans to follow the procedures, while reducing potential errors such as steps being omitted, or performed incorrectly or out of order, etc.

### SUMMARY

In some embodiments, a workflow progress presentation device comprises at least one processor, and at least one memory coupled to the at least one processor and configured to store executable instructions. The executable instructions, when executed by the at least one processor, cause the at least one processor to extract, from at least one data source, data corresponding to at least one element in a workflow diagram, determine from the extracted data whether the at least one element is active or completed, in response to determining that the at least one element is active, visually present the at least one element in the workflow diagram by a first format, and in response to determining that the at least one element is completed, visually present the at least one element in the workflow diagram by a second format visually distinctive from the first format.

In some embodiments, a method of presenting workflow progress in a workflow diagram is performed at least in part by at least one processor and comprises extracting, from at least one data source, data corresponding to at least one element in the workflow diagram, determining from the extracted data whether the at least one element is active, completed, or reopened, and visually presenting the at least one element in the workflow diagram. The at least one element is visually presented by a first format, in response to determining that the at least one element is active. The at least one element is visually presented by a second format, in response to determining that the at least one element is completed. The at least one element is visually presented by a third format, in response to determining that the at least one element is reopened. The first through third formats are visually distinctive from each other, and from a fourth format of other elements, which are neither active, completed nor reopened, in the workflow diagram.

In some embodiments, a computer program product comprises a non-transitory, tangible computer readable storage medium storing a computer program that, when executed by at least one processor, causes the at least one processor to perform a first algorithm to extract, from at least one data source, data corresponding to a plurality of elements in a workflow diagram, and then perform a second algorithm to generate and visually present a graphic user interface (GUI) including the workflow diagram. The workflow diagram in the GUI includes at least one first element among the plurality of elements of the workflow diagram is visually presented in a first format indicating, based on the extracted data, that the at least one first element is active. The workflow diagram in the GUI further includes at least one second element among the plurality of elements of the workflow diagram is visually presented in a second format indicating, based on the extracted data, that the at least one second element is completed. The workflow diagram in the GUI further includes at least one third element among the plurality of elements of the workflow diagram is visually presented in a third format indicating, based on the extracted data, that the at least one third element has been completed before and is now reopened. The workflow diagram in the GUI further includes at least one fourth element among the plurality of elements of the workflow diagram is visually presented in a fourth format indicating, based on the extracted data, that the at least one fourth element is neither active, completed nor reopened. The first through fourth formats are visually distinctive from each other.

### BRIEF DESCRIPTION OF THE DRAWINGS

Aspects of the present disclosure are best understood from the following detailed description when read with the accompanying FIGS. In accordance with the standard practice in the industry, various features are not drawn to scale. In fact, the dimensions of the various features be arbitrarily increased or reduced for clarity of discussion.

FIG. 1 is a schematic diagram of a system with a workflow progress presentation device, in accordance with some embodiments.

FIG. 2 is a schematic view of example tables serving as data sources for a workflow progress presentation device, in accordance with some embodiments.

FIG. 3 is a flow chart of a process performed by a workflow progress presentation device, in accordance with some embodiments.

FIGS. 4A-4E are schematic diagrams of a graphic user interface (GUI) including a workflow diagram at various visually presented states as the corresponding workflow progresses, in accordance with some embodiments.

FIG. 5 is a schematic block diagram of a computer system, in accordance with some embodiments.

### DETAILED DESCRIPTION

The following disclosure includes many different embodiments, or examples, for implementing different features of the subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows include embodiments in which the first and second features are formed in direct contact, and also include embodiments in which additional features be formed between the first and second features, such that the first and second features not be in direct contact. In addition, the present disclosure repeats reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, be usable herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus be otherwise oriented (rotated 90 degrees or at other orientations) and the spatially relative descriptors usable herein likewise be interpreted accordingly.

A workflow is a description, in a step-by-step manner, of a process for how work is to be done. Examples of processes include, but are not limited to, procedures, business and/or technical plans, or the like. A workflow diagram is a diagram for describing, or visually presenting, a workflow. Although workflow diagrams are useful for presenting/describing complex procedures, business and/or technical plans in an easy-to-under-stand manner, there are currently no tools for showing how the workflow, i.e., the plan or procedure, described by the workflow diagram progresses.

In some embodiments, a workflow progress presentation device is configured to extract data corresponding to one or more elements of a workflow diagram, and, based on the extracted data, visually present the one or more elements of the workflow diagram in various, visually distinctive formats, depending on whether the elements are active (or open), completed or reopened. As a result, in at least one embodiment, it is possible and/or easy for a user, to whom the workflow diagram is visually presented, to understand the current status of the workflow, i.e., which element has been completed, which element is currently active and needs to be worked on, and/or which element has been completed before and now becomes active again. Accordingly, in at least one embodiment, the issue of stage tracking can be solved and/or the user is enabled to identify the stage of progress of the workflow. This is an improvement over other approaches which lack a tool or a user interface to display the progress of a workflow. As a result, it is possible, in at least one embodiment, to reduce cost, time, labor, and/or user skill level required for tracking workflow progresses. Further features and/or advantages are within the scopes of various embodiments.

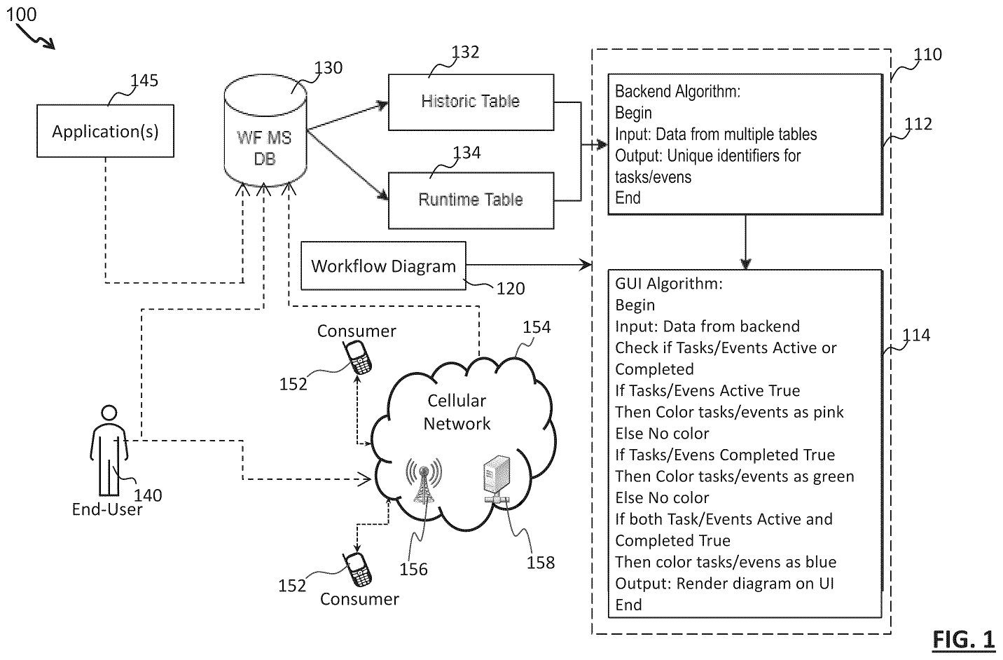

FIG. 1 is a schematic diagram of a system 100 with a workflow progress presentation device 110, in accordance with some embodiments.

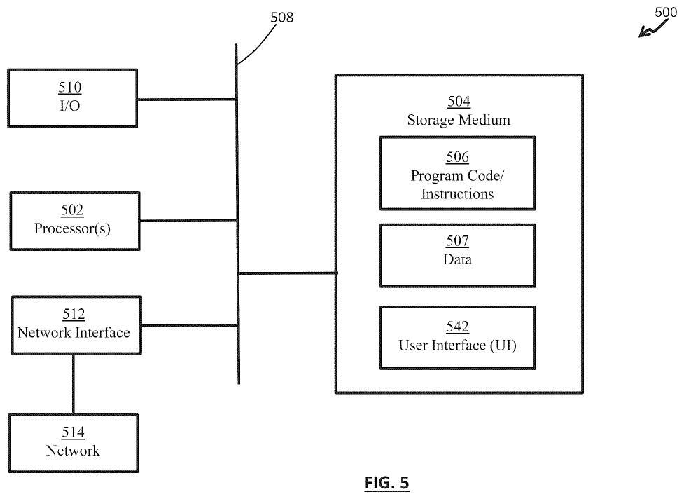

In some embodiments, the workflow progress presentation device 110 comprises hardware on/by which software corresponding to various algorithms and/or operations described here is executed. An example hardware configuration for the workflow progress presentation device 110 includes a computer system described with respect to FIG. 5. For example, the workflow progress presentation device 110 includes executable instructions stored in at least one memory and executed by at least one processor. The executable instructions of the workflow progress presentation device 110 define a first algorithm 112 (also referred to herein as backend algorithm 112), and a second algorithm 114 (also referred to herein as graphic user interface (GUI) algorithm 114). The division of the executable instructions of the workflow progress presentation device 110 into two algorithms is just an example. Other arrangements are within the scopes of various embodiments, e.g., a single algorithm or more than two algorithms may be included in the executable instructions of the workflow progress presentation device 110 to perform some or all of the functionality and/or operations described herein. Details of the backend algorithm 112 and GUI algorithm 114 are described hereinafter.

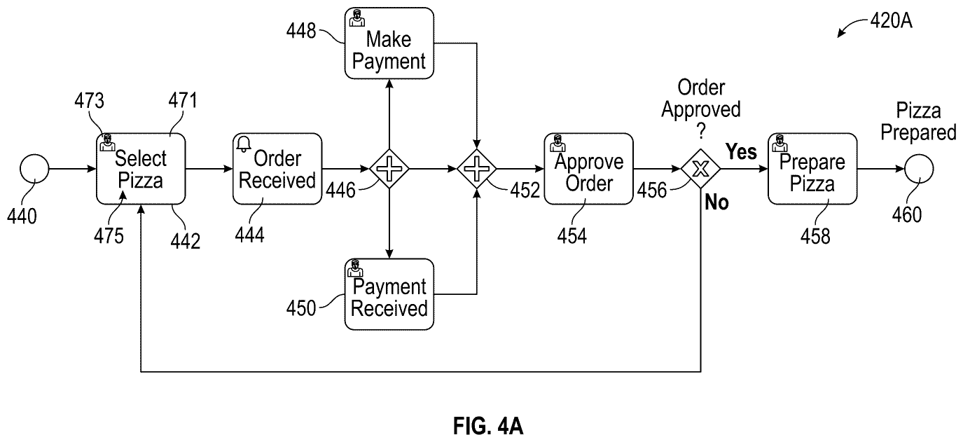

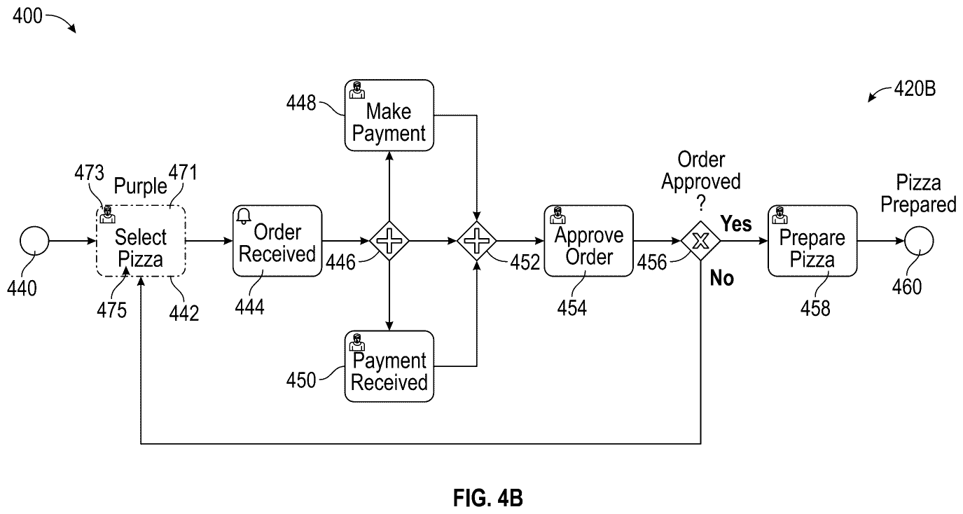

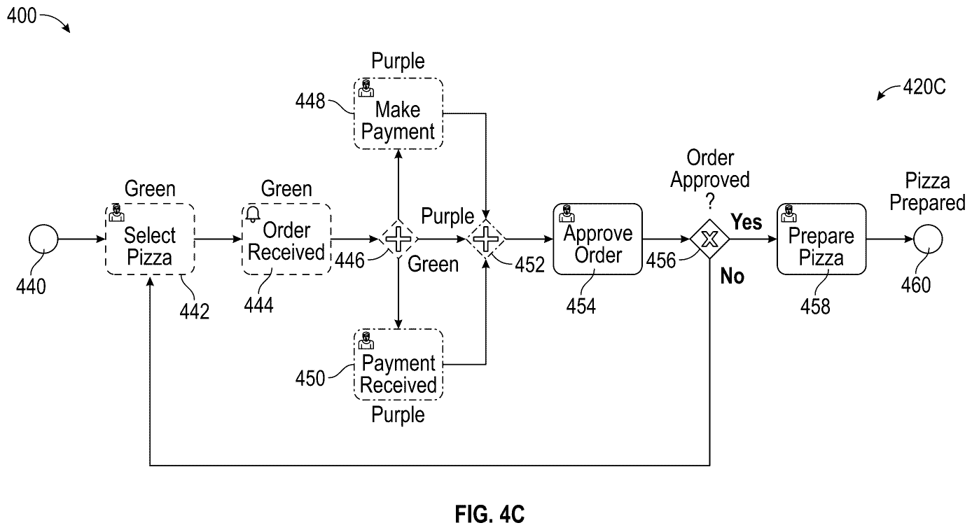

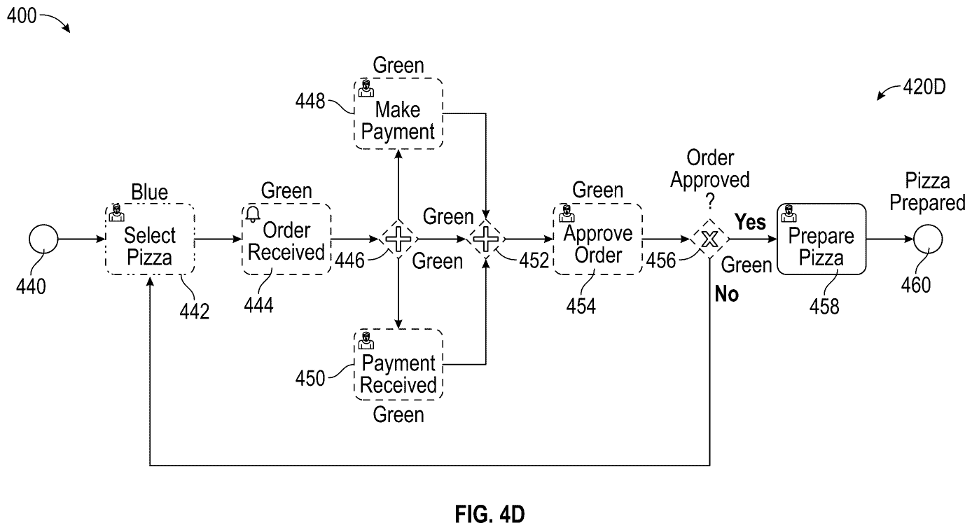

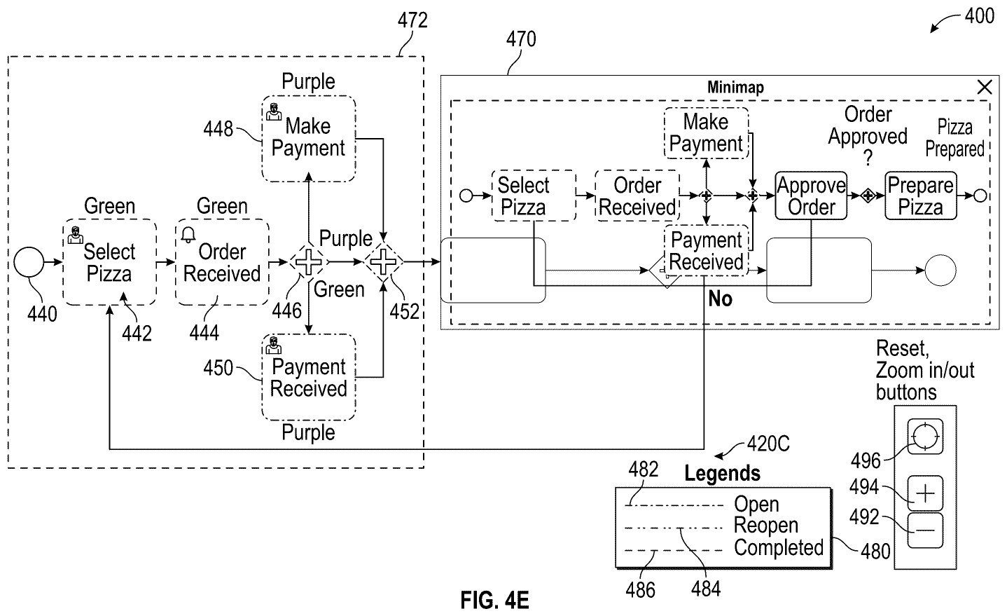

The workflow progress presentation device 110 is configured to visually present one or more elements of a workflow diagram 120 in various, visually distinctive formats to show progress of a workflow described by the workflow diagram 120. A non-limiting example of the workflow diagram 120 at various stages of workflow progress, with changing formats of one or more elements, is described with respect to FIGS. 4A-4E. In some embodiments, the workflow diagram 120 is generated by a third party's software, such as Camunda. Other workflow generation platforms and/or applications are usable with the workflow progress presentation device 110 in some embodiments.

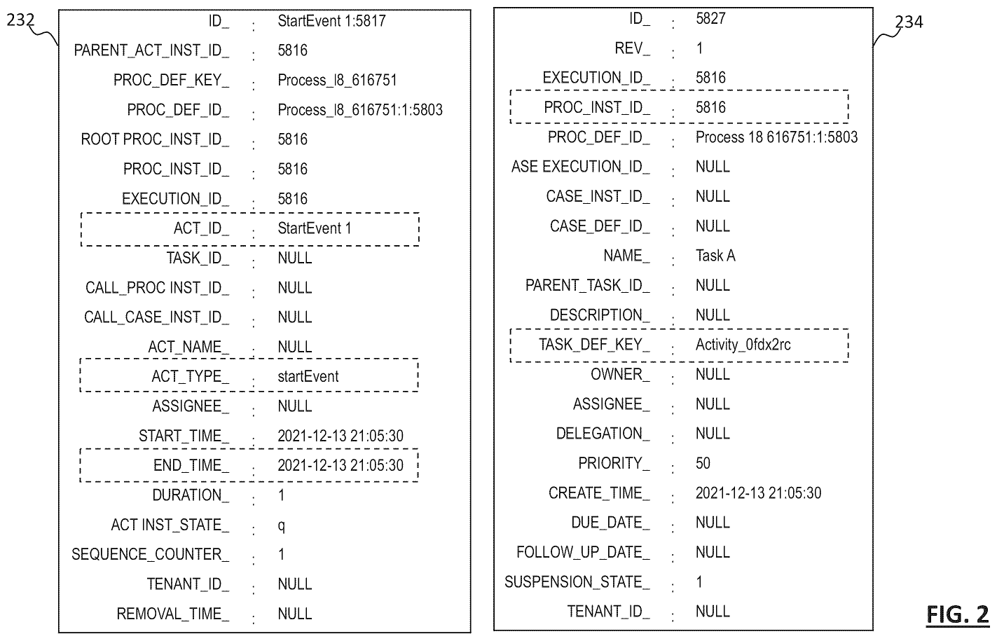

The workflow progress presentation device 110 is configured to determine visually distinctive formats of various elements in the workflow diagram 120, based on data corresponding to the elements of the workflow diagram and extracted from one or more data sources. Example data sources include relations and/or tables stored in one or more databases. In the example configuration in FIG. 1, a database 130 includes a plurality of tables, two of which, i.e., a history table 132 and a runtime table 134, form the data sources for the workflow progress presentation device 110. Non-limiting examples of the history table 132 and runtime table 134 are described with respect to FIG. 2. In at least one embodiment, the database 130 is a workflow management systems (WF MS) database. The described database, history table and runtime table are example data sources. Other data sources, e.g., other tables and/or other databases, are within the scopes of various embodiments.

In some embodiments, the database 130 contain data corresponding to one or more workflows. The data are entered, manipulated and/or updated manually and/or automatically. For example, data corresponding to one or more workflows are manually entered and/or updated by an end-user 140. In the example configuration in FIG. 1, the end-user 140 enters data into the database 130 while performing one or more tasks related to a cellular network. This is only an example application of an industry or field where the workflow progress presentation device 110 is usable. The workflow progress presentation device 110 is applicable in any other fields, industries, applications, services, etc., where workflow diagrams are used for visualizing workflows and/or processes, in accordance with some embodiments.

In the cellular network example in FIG. 1, consumers' mobile terminals 152 are coupled to the cellular network 154 to receive communication services. In an example, the cellular network 154 comprises a plurality of cells (not shown) in which cellular services are provided, through corresponding base stations. A representative base station 156 is illustrated in FIG. 1. The base stations constitute a radio access network, and are coupled to a core network of the cellular network 154. A representative network device 158 of the core network is illustrated in FIG. 1. Examples of the cellular network 154 include, but are not limited to, a long term evolution (LTE) network, a fifth generation (5G) network, a non-standalone (NSA) network, a standalone (SA) network, a global system for mobile communications (GSM) network, a general packet radio service (GPRS) network, a code-division multiple access (CDMA) network, a Mobitex network, an enhanced GPRS (EDGE) cellular network, or the like. Example configurations of the base stations include cell towers each having one or more cellular antennas, one or more sets of transmitter/receivers transceivers, digital signal processors, control electronics, a Global Positioning System (GPS) receiver for timing (e.g., for CDMA2000/IS-95 or GSM systems), primary and backup electrical power sources, and sheltering. Examples of mobile terminals 152, include, but are not limited to, cell phones, tablets, media players, gaming consoles, personal data assistants (PDAs), laptops, and other electronic devices configured to transmit and/or receive cellular communication to/from the base stations of the cellular network 154. An example hardware configuration of a mobile terminal and/or a base station includes a computer system described with respect to FIG. 5, with the addition of one or more cellular antennas and corresponding cellular transceiving circuitry. Examples of communication technologies for performing cellular communications between base stations and mobile terminals include, but are not limited to, 2G, 3G, 4G, 5G, GSM, EDGE, WCDMA, HSPA, CDMA, LTE, DECT and WiMAX. Examples of services provided over cellular communication, herein referred to as cellular communication services, include, but are not limited to, voice calls, data, emails, messages such as SMS and MMS, applications, and control signals. Example components (or network devices 158) of the core network include, but are not limited to, serving gateways (SGW), high rate packet data serving gateway (HSGW), packet data network gateway (PGW), packet data serving node (PDSN), mobility management entity (MME), home subscriber server (HSS), and policy control rules function (PCRF). The components of the core network are coupled with each other and with the base stations by one or more public and/or proprietary networks. An example hardware configuration of a component or network device 158 of the core network includes a computer system described with respect to FIG. 5.

Example tasks that the end-user 140 may perform include, but are not limited to, surveying a physical site for installing a base station, checking operations of various equipment at a base station or a network device, or the like. The end-user 140 may manually enter data obtained from the performed task (or cause a device to enter the obtained data) into the database 130. As illustrated in FIG. 1, data may also be automatically entered into the database 130 by software and/or equipment of the cellular network 154, and/or by external software and/or equipment schematically designated as application(s) 145. The entered data are stored in various tables of the database 130, including the history table 132 and runtime table 134. In some embodiments, the history table 132 includes data corresponding to completed tasks and/or events, whereas the runtime table 134 includes data corresponding to active (or open) tasks and/or events. The tasks/events correspond to various elements in the workflow diagram 120. Other configurations are within the scopes of various embodiments.

The backend algorithm 112, when executed by at least one processor, causes the at least one processor to extract, from at least one data source, data corresponding to a plurality of elements in a workflow diagram. For example, the backend algorithm 112, when executed, causes the at least one processor to extract, from the history table 132 and/or the runtime table 134, data corresponding to elements of the workflow diagram 120. In at least one embodiment, the backend algorithm 112, when executed, causes the at least one processor to extract unique identifiers of tasks/events corresponding to elements of the workflow diagram. The extracted data, e.g., unique identifiers of tasks/events, are output to the GUI algorithm 114. In some embodiments, executable instructions or codes of the backend algorithm 112 are developed in Java programming language, and cause the at least one processor to fetch or extract data corresponding to the unique identifiers and/or current status of the tasks/events of the workflow from the history table 132 and/or runtime table 134 of the database 130, and then integrate the extracted data into a well-formed JavaScript Object Notation (JSON) file or code. The JSON file or code is then used as input for the GUI algorithm 114.

The GUI algorithm 114, when executed by at least one processor, causes the at least one processor to generate and visually present a graphic user interface (GUI) including the workflow diagram in which various elements of the workflow diagram are visually presented in various, visually distinctive formats, depending on whether the elements are active (or open), completed or reopened. The GUI algorithm 114 determines whether an element of the diameter is active, completed or reopened based on the data extracted by the backend algorithm 112 and fed to the GUI algorithm 114. In some embodiments, the executable instructions or codes of the GUI algorithm 114 are developed as JSON code in Angular, which is a platform for building mobile and/or desktop web applications. Other platforms and/or software configurations are within the scopes of various embodiments. The GUI generated by the GUI algorithm 114 is visually presented to an user to help the user to understand the workflow progress based on different visually distinctive formats of various elements in the workflow diagram.

In some embodiments, a user is someone who reviews or supervises or manages how a process, or workflow, is being performed, whereas an end-user, e.g., end-user 140, is someone who performs one or more tasks in the workflow and enters data corresponding to the performed tasks into the database 130. The workflow progress presentation device 110 extracts data corresponding to the workflow from the database 130, and visually presents a GUI to the user (e.g., a supervisor or manager). The GUI includes a workflow diagram describing the workflow. The workflow diagram may be generated by a third party's program/software, e.g., Camunda as described herein. However, one or more elements in the workflow diagram are modified or rendered with various visually distinctive formats by the workflow progress presentation device 110 to show the workflow progress.

In some embodiments, an example of visual presentation of a workflow diagram and/or elements thereof includes displaying the workflow diagram and/or elements thereof on a display, such as a monitor or a touch screen. The display may be a display of a computer system implementing the workflow progress presentation device 110, or a remote display coupled to the workflow progress presentation device 110 by a network or communication link. Other ways for visually presenting information, such as projection on a screen, three-dimensional (3D) projection, using glasses and/or other head-mounted devices, or any other manners for presenting information to be visually perceptible by a user, are within the scopes of various embodiments. For simplicity, “displaying” or “displayed” may be used in the following description as an example manner for visual presentation of information. Other manners for visual presentation, as discussed herein, are not excluded. A user may interact with displayed, or otherwise visually presented, information by a pointing device (e.g., a mouse), a touch screen, contact-less gestures, voice commands, or the like.

In some specific embodiments described herein, visually distinctive formats include different colors, e.g., the color green for a completed task or element, the color purple (or pink) for an active task or element, and the color blue for a reopened task or element. Any other schemes with visually distinctive formats are within the scopes of various embodiments. For example, elements in the workflow diagram which are presented in visually distinctive formats may have various degrees of transparency, may be blinking or otherwise animated, may be with or without shadows, may have different font types, font colors and/or font variations (e.g., bold or italicized text), may have different icons and/or text added to or over the elements originally generated by a third party's software, may have different combinations of the above visual effects and/or other effects not specifically described herein.

Non-limiting examples of data sources used by the workflow progress presentation device 110, one or more operations and algorithms of the workflow progress presentation device 110, and various views of a GUI visually presented by the workflow progress presentation device 110 are described with respect to FIGS. 2-4E.

FIG. 2 is a schematic view of example tables 232, 234 serving as data sources for the workflow progress presentation device 110, in accordance with some embodiments.

The table 232 is a history table corresponding to the history table 132 in a WF MS database 130, in accordance with some embodiments. The history table 232 includes a plurality of fields, such as “ID_”, “PARENT_ACT_INST_ID_”, or the like. For each field, the history table 232 includes corresponding data, such as data “StartEvent 1:5817” for field “ID_”, data “5816” for field “PARENT_ACT_INST_ID_”, or the like. In the example configuration in FIG. 2, all data shown for all fields in the history table 232 belong to a single record, e.g., a single task or event (hereinafter “task/event”) in a workflow to be performed. The history table 232 is configured to store data corresponding to one or more completed tasks/events. The backend algorithm 112 of the workflow progress presentation device 110 is configured to extract data corresponding to at least fields “ACT_ID_”, “ACT_TYPE_” and “END_TIME_” from the history table 232. Field “ACT_ID_” indicates a unique identifier of a task/event. Field “ACT_TYPE_” indicates an activity type of the task/event. Examples of activity types include, but are not limited to, user task, message task, start timer, various types of activity in Business Project Management Notation (BPMN), or the like. This field helps to identify the activity type of task/events on the GUI and/or the backend algorithm. Field “END_TIME” indicates the time and/or date when the task/event was completed.

The table 234 is a runtime table corresponding to the runtime table 134 in the WF MS database 130, in accordance with some embodiments. The runtime table 234 includes a plurality of fields, such as “ID_”, “REV_”, or the like. For each field, the runtime table 234 includes corresponding data, such as data “5827” for field “ID_”, data “1” for field “REV_”, or the like. In the example configuration in FIG. 2, all data shown for all fields in the runtime table 234 belong to a single record, e.g., a single task/event in a workflow to be performed. The runtime table 234 is configured to store data corresponding to one or more active (or open) tasks/events. The backend algorithm 112 of the workflow progress presentation device 110 is configured to extract data corresponding to at least fields “TASH_DEF_KEY_” and “PROC_INST_ID_” from the runtime table 234. Field “TASK_DEF_KEY_” indicates a unique identifier of a task/event. Field “PROC_INST_ID_” indicates a unique identifier for single execution instance. An example is a primary key of a row in a table. This field is used to fetch single instance data. For example, in one workflow, there are multiple types of events and their activity is stored in multiple tables in one or more databases. With the help of this field, it is possible to collect data from such multiple tables and binding the collected data on a single stream of data.

In an example data extraction, the workflow diagram 120 includes an element associated with a unique identifier “StartEvent 1”. The backend algorithm 112 is configured to search in the history table 232 and the runtime table 234 for one or more records (e.g., tasks/events) having the unique identifier “StartEvent 1”. For example, the backend algorithm 112 found no matching task/event in the runtime table 234, but found a matching task/event in the history table 232 with the unique identifier “StartEvent 1” in the corresponding field “ACT_ID_”. The backend algorithm 112 is configured to extract data of this matching task/event, including data “StartEvent 1” in field “ACT_ID_”, data “startEvent” in field “ACT_TYPE_”, and data “2021-12-13 21:05:30” in field “END_TIME_”. Similarly, one or more further tasks/events having the same unique identifier(s) as corresponding one or more elements in the workflow diagram 120 are found by the backend algorithm 112 searching the history table 232, and data thereof are extracted.

In another example data extraction, the workflow diagram 120 includes an element associated with a unique identifier “Activity_Ofdx2rc”. The backend algorithm 112 is configured to search in the history table 232 and the runtime table 234 for one or more records (e.g., tasks/events) having the unique identifier “Activity_Ofdx2rc”. For example, the backend algorithm 112 found no matching task/event in the history table 232, but found a matching task/event in the runtime table 234 with the unique identifier “Activity_Ofdx2rc” in the corresponding field “TASK_DEF_KEY_”. The backend algorithm 112 is configured to extract data of this matching task/event, including data “Activity_Ofdx2rc” in field “TASK_DEF_KEY_”, and data “5816” in field “PROC_INST_ID_”. Similarly, one or more further tasks/events having the same unique identifier(s) as corresponding one or more elements in the workflow diagram 120 are found by the backend algorithm 112 searching the runtime table 234, and data thereof are extracted.

In some embodiments, the extracted data from the history table 232 and runtime table 234 are integrated into a well-formed JSON file or code which is then fed to the GUI algorithm 114, as described herein. Although not illustrated in FIG. 2, there are situations where the same unique identifier is found in both the history table 232 and the runtime table 234, indicating that the corresponding task/event is both completed and active. Such a task/event is determined by the GUI algorithm 114 as being a reopened task/event, as described herein.

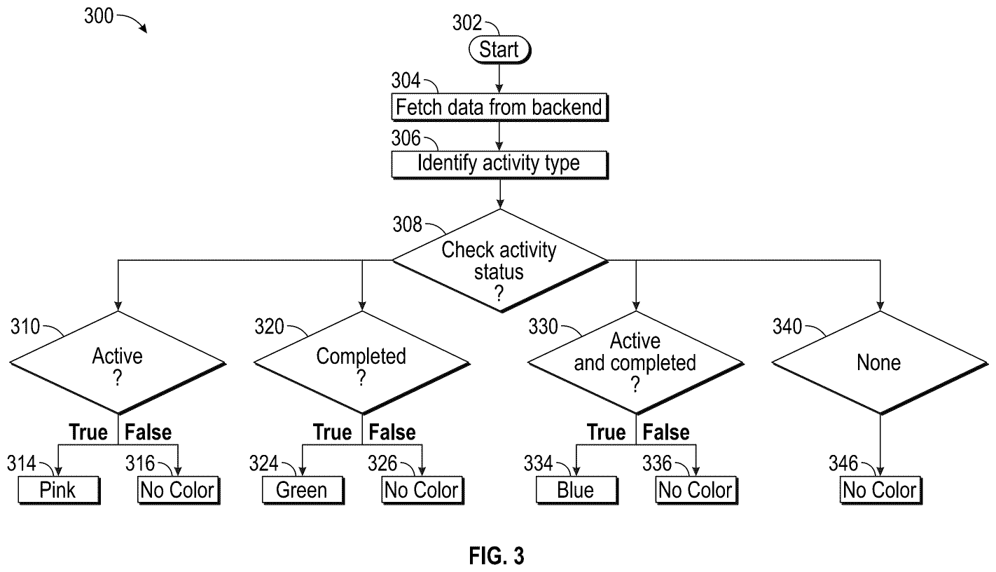

FIG. 3 is a flow chart of a process 300 performed by a workflow progress presentation device, in accordance with some embodiments. In some embodiments, the process 300 is performed by at least one processor of the workflow progress presentation device 110. The process 300 includes operation 304 corresponding to the backend algorithm 112, and operations 306-346 corresponding to the GUI algorithm 114.

At operation 302, the process 300 starts. In some embodiments, the process 300 starts when a user (e.g., a supervisor, manager) causes the workflow progress presentation device 110 to access the workflow diagram 120. Accessing the workflow diagram 120 may comprises accessing the workflow diagram 120 for a very first time after the workflow diagram 120 is generated by a third party's software, or accessing the workflow diagram 120 again after the workflow diagram 120 was previously accessed by the workflow progress presentation device 110. The process then proceeds to operation 304.

At operation 304, data are read from the backend. As described with respect to FIGS. 1-2, the backend includes one or more databases 130 each including one or more history tables 132, 232 and/or one or more runtime tables 134, 234. Data in the one or more databases, and/or history tables, and/or runtime tables are read or accessed for data extraction.

In some embodiments, the unique identifiers of one or more tasks/events (designated as Task ID and Even ID in FIG. 3) corresponding elements in the workflow diagram 120 are extracted. For example, as described with respect to FIG. 2, the backend algorithm 112 causes at least one processor of the workflow progress presentation device 110 to search one or more history tables and/or one or more runtime tables in one or more databases in the backend for matching records (e.g., tasks/events) that have the same unique identifiers as those associated with elements in the workflow diagram 120. The unique identifiers and associated data of the matching tasks/events are extracted and incorporated in a JSON file or code, as described herein. The extracted data are output by the backend algorithm 112, and the process proceeds to operation 306.

Subsequent operations 306-346 are performed by at least one processor of the workflow progress presentation device 110 executing the GUI algorithm 114, with respect to each task/event included in the data extracted by the backend algorithm 112.

At operation 306, the GUI algorithm 114 causes the at least one processor to identify the activity type of a current activity in the extracted data, to determine whether it is a task or an event. The process then proceeds to operation 308.

At operation 308, the GUI algorithm 114 causes the at least one processor to check activity status of the current task/event. The activity status can be one of active, completed, both active and completed, or none, i.e., neither active or completed. In an example, the current task/event is determined as active in response to the current task/event being extracted from a runtime table, i.e., the unique identifier of the current task/event was found in a predetermined field in the runtime table. In another example, the current task/event is determined as completed in response to the current task/event being extracted from a historic table, i.e., the unique identifier of the current task/event was found in a predetermined field in the historic table.

In response to the activity status of the current task/event being determined at operation 308 as active, the process proceeds to operation 310. In response to the activity status of the current task/event being determined at operation 308 as completed, the process proceeds to operation 320. In response to the activity status of the current task/event being determined at operation 308 as both active and completed, the process proceeds to operation 330. In response to the activity status of the current task/event being determined at operation 308 as none, i.e., neither active or completed, the process proceeds to operation 340.

At operation 310, the GUI algorithm 114 causes the at least one processor to confirm the active activity status of the current task/event. In response to the active activity status of the current task/event being confirmed (True), the process proceeds to operation 314. Otherwise (False), the process proceeds to operation 316.

At operation 314, i.e., in response to the current task/event being confirmed as active, the GUI algorithm 114 decides to render a first visually distinctive format (active format) for an element in the workflow diagram 120 that corresponds to the current, active task/event. In the example configuration in FIG. 3, the active format includes rendering the corresponding element in the purple (or pink) color. Other visually distinctive formats are within the scopes of various embodiments.

At operation 316, i.e., in response to the current task/event being not confirmed as active, the GUI algorithm 114 decides to render the corresponding element in the workflow diagram 120 in a fourth format corresponding to tasks/events that are neither active, completed nor reopened. For example, the GUI algorithm 114 may decide to maintain the corresponding element in a format originally given to that element when the workflow diagram 120 is generated by a third party's software. In the example configuration in FIG. 3, no special color is given to elements corresponding to tasks/events that are neither active, completed nor reopened. Other visually distinctive formats are within the scopes of various embodiments.

At operation 320, the GUI algorithm 114 causes the at least one processor to confirm the completed activity status of the current task/event. In response to the completed activity status of the current task/event being confirmed (True), the process proceeds to operation 324. Otherwise (False), the process proceeds to operation 326.

At operation 324, i.e., in response to the current task/event being confirmed as completed, the GUI algorithm 114 decides to render a second visually distinctive format (completed format) for the element in the workflow diagram 120 that corresponds to the current, completed task/event. In the example configuration in FIG. 3, the completed format includes rendering the corresponding element in the green color. Other visually distinctive formats are within the scopes of various embodiments.

At operation 326, i.e., in response to the current task/event being not confirmed as completed, the GUI algorithm 114 decides to render the corresponding element in the workflow diagram 120 in the fourth format corresponding to tasks/events that are neither completed, completed nor reopened. For example, the GUI algorithm 114 may decide to maintain the corresponding element in the format originally given to that element when the workflow diagram 120 is generated by a third party's software. In the example configuration in FIG. 3, no special color is given to elements corresponding to tasks/events that are neither completed, completed nor reopened. Other visually distinctive formats are within the scopes of various embodiments.

At operation 330, the GUI algorithm 114 causes the at least one processor to confirm the active and completed activity status of the current task/event. In an example, the current task/event is both active and completed when the unique identifier of the current task/event is included in both the data extracted from the runtime table(s) and the data extracted from the historic table(s). In response to the active and completed activity status of the current task/event being confirmed (True), the process proceeds to operation 334. Otherwise (False), the process proceeds to operation 336.

At operation 334, i.e., upon confirming that the current task/event is both active and completed, the GUI algorithm 114 determines the current task/event as reopened, i.e., a task/event that has been completed before and now becomes active again. The GUI algorithm 114 decides to render a third visually distinctive format (reopened format) for the corresponding element. In the example configuration in FIG. 3, the reopened format includes rendering the corresponding element in the blue color. Other visually distinctive formats are within the scopes of various embodiments.

At operation 336, i.e., in response to the current task/event being not confirmed as both active and completed, the GUI algorithm 114 decides to render the corresponding element in the workflow diagram 120 in the fourth format corresponding to tasks/events that are neither completed, completed nor reopened. For example, the GUI algorithm 114 may decide to maintain the corresponding element in the format originally given to that element when the workflow diagram 120 is generated by a third party's software. In the example configuration in FIG. 3, no special color is given to elements corresponding to tasks/events that are neither completed, completed nor reopened. Other visually distinctive formats are within the scopes of various embodiments.

At operation 340, i.e., in response to the GUI algorithm 114 obtaining none as the activity status of the current task/event, the process proceeds to operation 346.

At operation 346, i.e., when the activity status of the current task/event is none, the GUI algorithm 114 decides to render the corresponding element in the workflow diagram 120 in the fourth format corresponding to tasks/events that are neither completed, completed nor reopened. For example, the GUI algorithm 114 may decide to maintain the corresponding element in the format originally given to that element when the workflow diagram 120 is generated by a third party's software. In the example configuration in FIG. 3, no special color is given to elements corresponding to tasks/events that are neither completed, completed nor reopened. Other visually distinctive formats are within the scopes of various embodiments.

When the process reaches one of operations 314, 316, 324, 326, 334, 336, 346, the decision at that operation determines the format to be rendered by the GUI algorithm 114 for the element corresponding to the current task/event. The process described with respect to operations 306-346 is repeated for each task/event in the data extracted by the backend algorithm 112 and the corresponding element in the workflow diagram 120, to determine the formats to be rendered for elements in the workflow diagram 120. Based on the determined formats, a GUI is generated or rendered by the GUI algorithm 114 and visually presented to the user. Non-limiting examples of such a GUI are described with respect to FIGS. 4A-4E.

FIGS. 4A-4E are schematic diagrams of a graphic user interface (GUI) 400 including a workflow diagram at various visually presented states as the corresponding workflow progresses, in accordance with some embodiments.

In FIG. 4A, the GUI 400 includes a workflow diagram 420A as generated by a third party's software. In some embodiments, the workflow diagram 420A corresponds to the workflow diagram 120 described herein. In the example configuration in FIG. 4A, the workflow diagram 420A is in compliance with the Business Project Management Notation (BPMN) specification. Other workflow diagram configurations and/or specifications are within the scopes of various embodiments.

The workflow diagram 420A comprises a plurality of elements 440-460 connected with each other by a plurality of connections (not numbered) to form a flowchart-type diagram that describes the corresponding workflow to be performed by one or more end-users and/or applications and/or equipment. There are several types of elements in the workflow diagram 420A. For example, the elements 440, 460 are start and end elements corresponding to the start and end of the workflow. Complex workflow diagrams may have multiple start elements and/or multiple end elements. Each of the start and end elements may correspond to an event. The elements 442-458 include one or more tasks, events and/or gateways. In some embodiments, a task is an activity or work that is executable and/or needs to be done. A task may be manually executed by an end-user, or automatically executed by an application or equipment as described herein. In the example configuration in FIG. 4A, the elements 442, 444, 448, 450, 454, 458 are tasks and correspond to various tasks to be performed in the workflow. In some embodiments, events are things that are supposed to happen. Example events include, but are not limited to, message, timer, signal, or the like. In some embodiments, a gateway defines one or more conditions or circumstances under which one or more tasks are to be done. Example gateways include, but are not limited to, exclusive gateways, inclusive gateways, parallel gateways, event-based (or event-triggered) gateway, or the like. In the example configuration in FIG. 4, the elements 446, 452 are parallel gateways, and the element 456 is an exclusive gateway.

The workflow progresses as described in the workflow diagram 420A. For example, when the start event 440 occurs, the workflow proceeds to the task 442, and the task 442 becomes active or open, i.e., the task 442 can now be worked on or executed. When the task 442 is executed, it becomes completed, and the next task 444 becomes active. When the task 444 is completed, the parallel gateway 446 becomes active and completed at the same time. The completed parallel gateway 446 simultaneously opens several paths for the workflow to progress, i.e., to any of the task 448, the task 450 or the parallel gateway 452. The tasks 448, 450 and the parallel gateway 452 become active. The parallel gateway 452 is not completed until all of the parallel gateway 446 and the tasks 448, 450 have been completed. When the parallel gateway 452 is completed, the task 454 becomes active. When the task 454 is completed, the exclusive gateway 456 becomes active. Depending on whether a condition is satisfied at the exclusive gateway 456, the workflow either progresses to the task 458, or returns to the task 442. When the condition is satisfied at the exclusive gateway 456, the workflow progresses to the task 458 which, when completed, causes the workflow to proceed to the end event 460. When the condition is not satisfied at the exclusive gateway 456, the workflow returns to the task 442 which is now reopened, because it has been completed before and now becomes active again.

In other approaches, as the workflow progresses as described above, the visual presentation, or format, of the elements in the workflow diagram 420A remain unchanged. For example, the task 442 has a background 471, an icon 473, and descriptive text 475 all of which remain unchanged in appearance or visual presentation, regardless of whether the task 442 is active, completed, reopened, or is in none of those three states. Other elements in the workflow diagram 420A generally have the same format, or visual presentation, as the task 442. For example, all elements in the workflow diagram 420A have the same color, e.g., white or transparent, in their backgrounds. It is impossible or at least very difficult for a user looking at the workflow diagram 420A to understand the current stage of the workflow. This issue becomes significant when the workflow diagram is a complex one with dozens, or even hundreds, elements.

In some embodiments, the workflow progress presentation device 110 is configured to render one or more elements of the workflow diagram 420A in corresponding visually distinctive formats to enable the user to understand the current progress (or stage) of the workflow.

An example is illustrated in FIG. 4B. In this example, when a user causes the workflow progress presentation device 110 to access the workflow diagram 420A, the workflow progress presentation device 110 executes the process 300, extracts data corresponding to the elements of the workflow diagram workflow diagram 420A from one or more data sources, and determines that the element or task 442 is active. The workflow progress presentation device 110 then includes the workflow diagram 420A in the GUI 400, but with the active element 442 being rendered in the first visually distinctive format which is visually distinctive from the format of the other elements of the workflow diagram. For example, as shown in FIG. 4B, the color of the active element 442, including the color of the background 471, icon 473, and descriptive text 475, is rendered by the workflow progress presentation device 110 as purple, whereas the color of the other elements remain black and white. Because the drawings of this patent application are not color drawings, the word “Purple” is illustrated in FIG. 4B in association with the active task 442 to designate that the color of the active task 442 is purple. The word “Purple” itself is not an actual part of the GUI 400. Similarly, the words “Purple”, “Green” and “Blue” are included in one or more of FIGS. 4B-4D to designate the corresponding colors, but are not actual parts of the GUI 400.

Thus, in FIG. 4B, the workflow diagram 420A is effectively transformed by the workflow progress presentation device 110 to a workflow diagram 420B which, by the first visually distinctive format, e.g., the color purple, enables the user to quickly and easily understand that the workflow is now at the task 442 which needs to be done for further progress. This is a significant advantage over the other approaches with the drawbacks as described herein.

Another example is illustrated in FIG. 4C. In this example, when the user causes the workflow progress presentation device 110 to, after some time, access the workflow diagram 420A again, the workflow progress presentation device 110 executes the process 300 again, extracts renewed data corresponding to the elements of the workflow diagram workflow diagram 420A from one or more data sources, and determines that the elements 442, 444, 446 are completed, and the elements 448, 450, 452 are active. The workflow progress presentation device 110 then includes the workflow diagram 420A in the GUI 400, but with the active elements 448, 450, 452 being rendered in the first visually distinctive format (e.g., the color purple), and the completed elements 442, 444, 446 being rendered in the second visually distinctive format (e.g., the color green), whereas the other elements of the workflow diagram remain black and white. Thus, in FIG. 4C, the workflow diagram 420A is effectively transformed by the workflow progress presentation device 110 to a workflow diagram 420C which, by the first and second visually distinctive formats, e.g., the colors purple and green, enables the user to quickly and easily understand the current stage of the workflow, i.e., which element(s) have been completed and which element(s) are now active and need to be done or executed. This effect is not achievable in the other approaches.

A further example is illustrated in FIG. 4D. In this example, when the user causes the workflow progress presentation device 110 to, after some further time, access the workflow diagram 420A once again, the workflow progress presentation device 110 executes the process 300 again, extracts further renewed data corresponding to the elements of the workflow diagram workflow diagram 420A from one or more data sources, and determines that the elements 444, 446, 448, 450, 452, 454, 456 are completed, and the element 442 is reopened. The workflow progress presentation device 110 then includes the workflow diagram 420A in the GUI 400, but with the completed elements 444, 446, 448, 450, 452, 454, 456 being rendered in the second visually distinctive format (e.g., the color green), and the reopened element 442 being rendered in a third visually distinctive format (e.g., the color blue), whereas the other elements of the workflow diagram remain black and white (e.g., the fourth format). Thus, in FIG. 4D, the workflow diagram 420A is effectively transformed by the workflow progress presentation device 110 to a workflow diagram 420D which, by the third and third visually distinctive formats, e.g., the colors green and blue, enables the user to quickly and easily understand the current stage of the workflow, i.e., the loop with the elements 442-456 has been completed, and now the workflow returns to the element 442 which is again active, i.e., reopened. This effect is not achievable in the other approaches.

As described with respect to FIGS. 4A-4D, the user may access the workflow diagram 420A multiple times, and each time the GUI 400 visually presents the workflow diagram with one or more elements rendered in visually distinctive formats to show thew workflow progress. As the workflow progresses, the format of an element in the GUI 400 may sequentially change through a series of formats corresponding to various states of the element. For example, the element 442 is initially in the fourth format (e.g., as generated by a third party's software) of black and white in FIG. 4A, then changes to the first visually distinctive format (e.g., purple) when the element 442 becomes active in FIG. 4B, then changes to the second visually distinctive format (e.g., green) when the element 442 is completed in FIG. 4C, then changes to the third visually distinctive format (e.g., blue) when the element 442 is reopened again in FIG. 4D.

FIG. 4E is a further schematic diagram of the GUI 400, in accordance with some embodiments. The GUI 400 in FIG. 4E visually presents, at the same time and/or on the same screen, a mini-map 470 over, or superposed on, an enlarged portion 472 of the workflow diagram 420C. The mini-map 470 includes the entire workflow diagram 420C at a smaller scale than the enlarged portion 472 of the workflow diagram 420C under the mini-map 470. The mini-map 470 is useful in situations where the workflow diagram is large or complex. The mini-map 470 gives the user an overview of the entire workflow diagram, whereas an interested portion of the workflow diagram (e.g., a portion with visually distinctive formats) is visually presented in a larger scale to show details that would be difficult to recognized from the mini-map 470.

The GUI 400 is further configured to permit the user to move the enlarged portion 472 to show other parts of the workflow diagram in greater detail. In some embodiments, the mini-map 470 remains visible while the enlarged portion 472 is moved to other parts of the workflow diagram. In at least one embodiment, such moving comprises dragging or scrolling the enlarged portion 472, and/or by selecting (e.g., clicking or touching) a desired part on the mini-map 470.

The GUI 400 further comprises a legend area 480 and a zoom area 490. The legend area 480 includes legends 482, 484, 486 that explain the meaning of the first-third visually distinctive formats given to active (open), completed and reopened elements of the workflow diagram. For example, the legend 482 includes a small purple square and the word “Open” to indicates that elements with the purple color are active. The legend 484 includes a small blue square and the word “Reopen” to indicates that elements with the blue color are reopened. The legend 486 includes a small green square and the word “Completed” to indicates that elements with the green color are completed. The zoom area 490 includes buttons 492, 494 for zooming out and in the enlarged portion 472 of the workflow diagram 420C. The zoom area 490 further includes a reset button 496 for resetting the enlarged portion 472 to a default view, e.g., for resetting the zoom level of the enlarged portion 472 to a default level and/or for moving the enlarged portion 472 to a default part of the workflow diagram. In some embodiments, at least one of the legend area 480 and zoom area 490 is omitted.

In some embodiments, the workflow progress presentation device 110 and/or the process and/or algorithms thereof make it easy for a user to check the progress of a workflow diagram, and/or to track a workflow task with the help of visually distinctive formats, such as colors in a secure manner which is faster and more convenient than other approaches. The advantages of one or more embodiments are further significant in a cellular network where stage wise call connections and process flows play a vital role to remain adhere to the service-level agreements (SLAs) and various timelines. These stages and call connections are sometimes large in number and hence difficult for manual tracking. The other approaches lack a friendly user interface to display the progress flow, provide no mechanism to check an execution process, i.e., where it is and on which step. The other approaches require technical expertization to use in build components, offer no possibility for customization preview diagrams with color logics and changes of icons of tasks, and provide no Rest API (RESTful application program interface API) which can produce a meaningful response with respect to workflow progress. The described issues of the other approaches are avoidable in some embodiments by the workflow progress presentation device 110 and/or the process and/or algorithms thereof.

Some embodiments provide auto highlighting of the workflow status. This enables users to identify the stage of the workflow with ease. In a first aspect, the auto highlighting of the workflow status is based on the logic. In a second aspect, the mechanism of tracking the execution of workflow uses colors with custom icons. In a third aspect, some embodiments provide a custom user-friendly GUI view to track request which is not available in other approaches. In a fourth aspect, some embodiments fetch data from multiple resources to develop a response, and the algorithm(s) enable(s) the user to generate meaningful workflow diagrams with the progress and/or status highlighted.

In some embodiments, the workflow progress presentation device 110 and/or the process and/or algorithms provide a simple way for users to check status of their process (workflow), without need of having any technical expertization to track the workflow. The workflow diagram is visually presented to show the progress in a manner that is easy to understand via the color code logic. Some embodiments further provide the mini-map functionality to zoom-in, zoom-out and preview the diagram in a particular view port or default view.

In some embodiments, the GUI is developed in Angular JSON with predefined meta data, provides the functionality to add colors and icons of every task according to the mechanism execution, and tracks exception and unexpected response in case of failure. In some embodiments, Java programing developed algorithms are used to execute all the functionality. In at least one embodiment, a mini-map (e.g., the mini-map 470) is included in the GUI which permits the user to see the whole workflow diagram in the mini-map, highlight the current viewport (e.g., the enlarged portion 472), and click/drag/scroll the mini-map to navigate the workflow diagram. In at least one embodiment, the GUI further comprises the zoom-in, zoom-out and reset functionality for checking the workflow diagram in every viewport.

In some embodiments, the flow of the algorithm of the workflow progress presentation device 110 for achieving the described objective(s) and/or advantage(s) includes fetching data from multiple sources, integrating the fetched data based on task ID and event ID, segregating the data based on active or completed stage, verifying the stages as completed or “in process”, and visually presenting the workflow diagram, with visually distinctive formatted elements showing progress, to the user based on the verification. The described data integration based on task ID and event ID are examples. Other technique for data integration are within the scopes of various embodiments.

In some embodiments, it is possible to render a workflow diagram with colors, by using a custom renderer to color icons and connections dynamically. In some embodiments, a custom logic is used for checking the status and adding custom icons for a meaningful GUI. In at least one embodiment, it is possible to reduce debugging time thanks to the ability to track the status of a particular task in a workflow diagram.

The described methods and algorithms include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

FIG. 5 is a schematic block diagram of a computer system 500, in accordance with some embodiments. Examples of the computer system 500 include, but are not limited to, desktop, a laptop, a tablet, a smart phone, a server, or the like.

The computer system 500 includes a hardware processor 502 and a non-transitory, computer-readable storage medium 504. Storage medium 504, amongst other things, is encoded with, i.e., stores, computer program code 506, i.e., a set of executable instructions, such as one or more algorithms, programs, applications, sets of executable instructions for a workflow progress presentation device, or the like, as described with respect to one or more of FIGS. 1-4E. Execution of instructions 506 by hardware processor 502 implements a portion or all of the methods described herein in accordance with one or more embodiments (hereinafter, the noted processes and/or methods).

Processor 502 is coupled to non-transitory computer-readable storage medium 504 via a bus 508. Processor 502 is also coupled to an I/O interface 510 by bus 508. A network interface 512 is connected to processor 502 via bus 508. Network interface 512 is connected to a network 514, so that processor 502 and computer-readable storage medium 504 are connectable to external elements or devices via network 514. Processor 502 is configured to execute computer program code 506 encoded in computer-readable storage medium 504 in order to cause computer system 500 to be usable for performing a portion or all of the noted processes and/or methods. In one or more embodiments, processor 502 comprises a central processing unit (CPU), a multi-processor, a distributed processing system, an application specific integrated circuit (ASIC), and/or a suitable hardware processing unit.

In one or more embodiments, computer-readable storage medium 504 comprises an electronic, magnetic, optical, electromagnetic, infrared, and/or a semiconductor system (or apparatus or device). For example, computer-readable storage medium 504 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 504 includes a compact disk-read only memory (CD-ROM), a compact disk-read/write (CD-R/W), and/or a digital video disc (DVD).

In one or more embodiments, storage medium 504 stores computer program code 506 configured to cause computer system 500 to be usable for performing a portion or all of the noted processes and/or methods. In one or more embodiments, storage medium 504 also stores information or data 507, such as event data, consumer data, business data, policies, component configurations or the like, used in a portion or all of the noted processes and/or methods.

I/O interface 510 is coupled to external circuitry. In one or more embodiments, I/O interface 510 includes a keyboard, keypad, mouse, trackball, trackpad, touchscreen, and/or cursor direction keys for communicating information and commands to processor 502. Computer system 500 is configured to receive information through I/O interface 510. The information received through I/O interface 510 includes one or more of instructions, data, policies, configurations and/or other parameters for processing by processor 502. The information is transferred to processor 502 via bus 508. Computer system 500 is configured to receive information related to a user interface through I/O interface 510. The information is stored in computer-readable storage medium 504 as user interface (UI) 542.

Network interface 512 allows computer system 500 to communicate with network 514, to which one or more other computer systems are connected. Network interface 512 includes wireless network interfaces such as BLUETOOTH, WIFI, WIMAX, GPRS, LTE, 5G, 6G, WCDMA, or the like; or wired network interfaces such as ETHERNET, USB, IEEE-864 or the like. In one or more embodiments, a portion or all of noted processes and/or methods, is implemented in two or more computer system 500.

In some embodiments, a portion or all of the noted processes and/or methods is implemented as a standalone software application for execution by one or more hardware processors. In some embodiments, a portion or all of the noted processes and/or methods is implemented as a software application that is a part of an additional software application. In some embodiments, a portion or all of the noted processes and/or methods is implemented as a plug-in to a software application.

In some embodiments, a portion or all of the noted processes and/or methods is realized as functions of a program stored in a non-transitory computer readable recording medium. The non-transitory computer readable recording medium having the program stored therein is a computer program product. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, or the like.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they make various changes, substitutions, and alterations herein without departing from the spirit and scope of the present disclosure.

What is claimed is:

1. A workflow progress presentation device, comprising:
at least one processor; and
at least one memory coupled to the at least one processor and configured to store executable instructions that, when executed by the at least one processor, cause the at least one processor to
extract, from at least one data source, data corresponding to at least one element in a workflow diagram,
determine from the extracted data whether the at least one element is active or completed,
in response to determining that the at least one element is active, visually present the at least one element in the workflow diagram by a first format, and
in response to determining that the at least one element is completed, visually present the at least one element in the workflow diagram by a second format visually distinctive from the first format.

2. The workflow progress presentation device of claim 1, wherein
the executable instructions, when executed by the at least one processor, further cause the at least one processor to
determine from the extracted data whether the at least one element is reopened,
in response to determining that the at least one element is reopened, visually present the at least one element in the workflow diagram by a third format visually distinctive from the first format and the second format.

3. The workflow progress presentation device of claim 2, wherein
the executable instructions, when executed by the at least one processor, further cause the at least one processor to
in response to determining that the at least one element is both completed and active, determine that the at least one element is reopened.

4. The workflow progress presentation device of claim 2, wherein
the first through third formats are visually distinctive from a fourth format of other elements, which are neither active, completed nor reopened, in the workflow diagram.

5. The workflow progress presentation device of claim 4, wherein
the first through fourth formats include different colors.

6. The workflow progress presentation device of claim 1, wherein
the at least one element of the workflow diagram comprises a task, a gateway, or an event.

7. The workflow progress presentation device of claim 1, wherein
the executable instructions, when executed by the at least one processor, further cause the at least one processor to visually present, at a same time,
the entire workflow diagram in a mini-map view at a smaller scale, and
a portion of the workflow diagram in an enlarged view at a larger scale.

8. The workflow progress presentation device of claim 1, wherein
the executable instructions, when executed by the at least one processor, further cause the at least one processor to, in response to user input, perform at least one of
moving the workflow diagram,
scaling up or down the workflow diagram, or
resetting the workflow diagram to a predetermined default view.

9. A method of presenting workflow progress in a workflow diagram, said method performed at least in part by at least one processor and comprising:
extracting, from at least one data source, data corresponding to at least one element in the workflow diagram;
determining from the extracted data whether the at least one element is active, completed, or reopened; and
visually presenting the at least one element in the workflow diagram
by a first format, in response to determining that the at least one element is active,
by a second format, in response to determining that the at least one element is completed, and
by a third format, in response to determining that the at least one element is reopened,
wherein the first through third formats are visually distinctive from each other, and from a fourth format of other elements, which are neither active, completed nor reopened, in the workflow diagram.

10. The method of claim 9, wherein
in response to determining that the at least one element is both completed and active, the at least one element is determined as being reopened.

11. The method of claim 9, wherein
the at least one data source comprises at least one of a runtime table or a historic table from at least one database.

12. The method of claim 11, wherein
said extracting comprises extracting data corresponding to a unique identifier of the at least one element from the at least one of the runtime table or the historic table.

13. The method of claim 12, wherein at least one of
in response to the unique identifier of the at least one element being included in the data extracted from the runtime table, determining that the at least one element is active,
in response to the unique identifier of the at least one element being included in the data extracted from the historic table, determining that the at least one element is completed, or
in response to the unique identifier of the at least one element being included in both the data extracted from the runtime table and the data extracted from the historic table, determining that the at least one element is completed.

14. The method of claim 9, wherein
the first through fourth formats include different colors.

15. The method of claim 9, wherein
the at least one element of the workflow diagram comprises a task, a gateway, or an event.

16. The method of claim 9, further comprising:
visually presenting, at a same time,
the entire workflow diagram in a mini-map view at a smaller scale, and
a portion of the workflow diagram in an enlarged view at a larger scale.

17. The method of claim 9, further comprising, in response to user input, at least one of:
moving the workflow diagram;
scaling up or down the workflow diagram; or
resetting the workflow diagram to a predetermined default view.

18. The method of claim 9, further comprising:
accessing the workflow diagram in multiple accesses in each of which all of said extracting, determining and visually presenting are performed,
wherein, as the workflow diagram progresses through the multiple accesses, the at least one element is visually presented sequentially in the fourth format, then in the first format, then in the second format.

19. The method of claim 18, wherein
as the workflow diagram progresses through the multiple accesses, and after the at least one element has been visually presented sequentially in the fourth format, then in the first format, then in the second format,
the at least one element is visually presented in the third format, indicating that the at least one element has been completed and is now active again.

20. A computer program product, comprising a non-transitory, tangible computer readable storage medium storing a computer program that, when executed by at least one processor, causes the at least one processor to:
perform a first algorithm to extract, from at least one data source, data corresponding to a plurality of elements in a workflow diagram, and then
perform a second algorithm to generate and visually present a graphic user interface (GUI) including the workflow diagram in which
at least one first element among the plurality of elements of the workflow diagram is visually presented, based on the extracted data, in a first format indicating that the at least one first element is active,
at least one second element among the plurality of elements of the workflow diagram is visually presented, based on the extracted data, in a second format indicating that the at least one second element is completed,
at least one third element among the plurality of elements of the workflow diagram is visually presented, based on the extracted data, in a third format indicating that the at least one third element has been completed before and is now reopened, and
at least one fourth element among the plurality of elements of the workflow diagram is visually presented, based on the extracted data, in a fourth format indicating that the at least one fourth element is neither active, completed nor reopened,
wherein the first through fourth formats are visually distinctive from each other.
